(19) United States
(12) Patent Application Publication
(10) Pub. No.: US 2005/0171842 A1
(43) Pub. Date: Aug. 4, 2005

(54) Method and system for incentivizing the promotion of a payment service

(76) Inventors: Alan Tien, Sunnyvale, CA (US); Dave McClure, San Mateo, CA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/772,530

(22) Filed: Feb. 4, 2004

(51) Int. Cl. G06F 17/60

(52) U.S. Cl. 705/14

(57) ABSTRACT

A method and an apparatus to incentivize a first party to refer a payment service to a second party. The method includes establishing an account for the second party, wherein the account is associated with one of a plurality of bonus programs and wherein the account is further associated with the first party; receiving a payment for the second party in the account; and automatically awarding a payout to the first party based on the payment to the account and the bonus program that is associated with the account.

### FIELD OF THE INVENTION

The present invention relates generally to the field of online promotions and, more specifically to incentivizing the promotion of a payment service.

### BACKGROUND OF THE INVENTION

A payment service enables buyers and sellers to make and receive payment for transacted merchandise. The payment service may directly promote its services to the buyers and sellers or indirectly promote its services by incentivizing a referrer.

Referrers of the payment service are diverse and may be represented over a wide spectrum. For instance, at one end of the spectrum may be found a company with a single employee that designs web sites for toy retailers. At the other end of a spectrum may be found a corporation that includes thousands of employees and provides Internet access, web hosting, security and managed services to retailers and wholesalers of all types of merchandise and services. Providing an incentive program that effectively incentivizes the broadest possible spectrum of referrers and economizes the resources of the payment service is a problem. Further, the provision of such incentives presents a number of technical challenges.

### SUMMARY OF THE INVENTION

A method to incentivize a first party to refer a payment service to a second party. The method includes establishing an account for the second party, wherein the account is associated with one of a plurality of bonus programs and wherein the account is further associated with the first party; receiving a payment to the account for the second party; and automatically awarding a payout to the first party based on the payment to the account for the first party and on the bonus program that is associated with the account.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a system to incentivize a first party to refer a payment service to a second party, according to an exemplary embodiment of the present invention;

FIG. 2 is a block diagram illustrating software and hardware components of the network-based payment machine, the referrer machine, the buyer machine and the merchant machine according to an exemplary embodiment of the present invention;

FIG. 3 is a block diagram illustrating an exemplary administrative module, an exemplary account module, an exemplary payment module and an exemplary award module;

FIG. 4 is a database diagram illustrating an exemplary database maintained and accessed via a database engine server that supports the network-based payment machine and illustrating various fields;

FIG. 5 is an interactive flow chart illustrating a method, according to an exemplary embodiment of the present invention, to incentivize a first party to refer a payment service to a second party;

FIG. 6 is an interactive flow chart illustrating a method, according to an exemplary embodiment of the present invention, to receive a payment for the second party;

FIG. 7 is an interactive flow chart illustrating a method, according to an exemplary embodiment of the present invention, to automatically determine an award and make a payout to a first party;

FIG. 8 is an interactive flow chart illustrating a method, according to an exemplary embodiment of the present invention, to add, edit and view a bonus program;

FIGS. 9-15 illustrate user interface screens, according to an exemplary embodiment of the present invention; and

FIG. 16 illustrates a diagrammatic representation of machine in the exemplary form of a computer system within which a set of instructions, for causing the machine to perform any one or more of the methodologies discussed herein, may be executed.

### DETAILED DESCRIPTION

A method and system to incentivize a first party to refer a payment service to a second party are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a method and system to incentivize a first party to refer a payment service to a second party. An administrator creates multiple bonus programs that are custom designed to incentivize a variety of first parties, in the exemplary form of referrers, promoters, or third party partners. The administrator creates each bonus program by configuring a set of adjustable bonus program parameters in a manner that provides an incentive to one or more referrers and economizes the resources of the payment service.

The referrer typically obtains promotional information regarding a bonus program by accessing a marketing web page on the network-based payment machine. After reading the details of the bonus program, the referrer may decide to refer the payment service to a second party, in the exemplary form of a merchant. The referrer refers the payment service to the merchant with a personalized referral link that provides a path to a web page (e.g., landing page) and includes values that identify the referrer and the bonus program. The referrer may obtain the personalized referral link from the marketing web page by copying the personalized referral link, by selecting a button that requests a referral e-mail that includes the personalized referral link, or by copying a payment service logo that includes the personalized referral link. The referrer may include the personalized referral link in a marketing e-mail that is sent to the merchant or include the payment service logo in the third party partners web site. The merchant may select the personalized referral link or the logo thereby triggering the payment service web site to serve up the landing page.

The landing page promotes the payment service to the merchant and provides a button that the merchant may select to establish an account with the payment service. Establishment of the account, via the landing page, ensures that the referrer and the identified bonus program are associated with the account that is associated with the merchant. Henceforth, all payments made to the account are evaluated under the associated bonus program in determining whether a payout is to be made to the associated referrer.

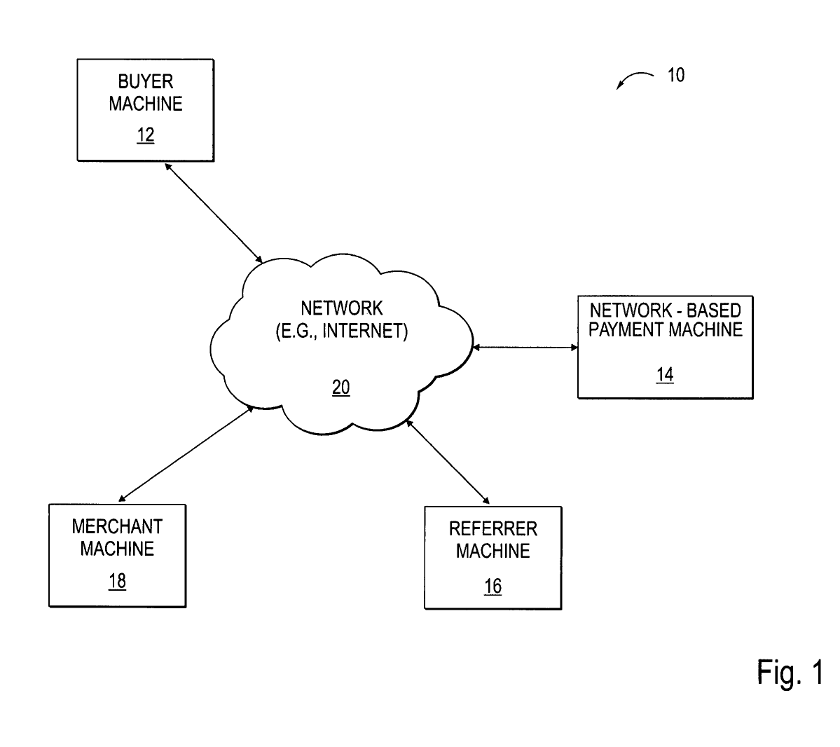

FIG. 1 is a block diagram illustrating a system 10 to incentivize a first party (e.g., referrer) to refer a payment service to a second party, according to an exemplary embodiment of the present invention. The system 10 includes a buyer machine 12, a network-based payment machine 14, a referrer machine 16, and a merchant machine 18 that communicate via a network 20. The network 20 may be embodied as Internet, a LAN, a WAN, PSTN, Frame Relay, ATM, satellite communications, wireless communications, combinations thereof, or any other network equipment or protocol that enables electronic communication between the above described network entities.

The buyer machine 12 enables a buyer to access the merchant machine 18 to purchase products and services and to access the network-based payment machine 14 to pay for the products and services.

The network-based payment machine 14 provides payment services that enable a user (e.g., a buyer, a seller) electronically to utilize e-mail to send and receive payments over the network 22. For example, the network-based payment machine 14 may be embodied as the Paypal™ Payment Service operated by PayPal of Mountain View, Calif.

The referrer machine 16 is utilized to provide referrals to merchants that operate the merchant machines 18. The referrer machine 16 may provide referrals in the exemplary form of marketing e-mails that are sent from the referrer machine 16 to the merchant machine 18, or in the exemplary form of payment service logos that appear on a landing web page served from the referrer machine 16.

The merchant machine 18 offers goods and services that may be electronically purchased by a buyer from the buyer machine 12. The buyer pays the corresponding merchant by sending an e-mail (or other electrical communication) to the network-based payment machine 14 wherein the e-mail authorizes payment to the merchant's account.

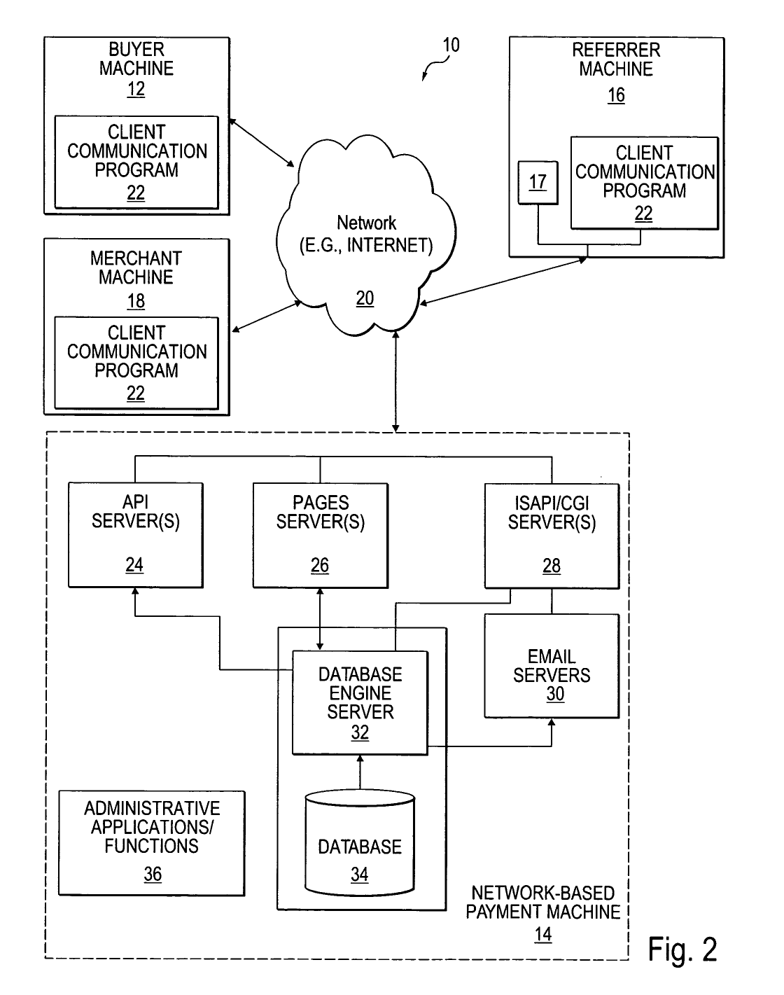

FIG. 2 is a block diagram illustrating software and hardware components of the buyer machine 12, the network-based payment machine 14, the referrer machine 16 and the merchant machine 18, according to an exemplary embodiment of the present invention.

In addition to other software components that are not illustrated, the buyer machine 12, the referrer machine 16 and the merchant machine 18 include a client communication program 22. The client communication program 22 enables a user to display web pages or e-mail that are received from server computers. The client communication program 22 may be embodied as a browser (e.g., the Microsoft Internet Explorer browser developed by Microsoft ™ Corporation of Redmond, Wash.). The client communication program 22 executes under an operating system (e.g., Microsoft ™ Windows developed by Microsoft ™ Corporation or Mac OS X developed by Apple Computer of Cupertino, Calif.). The client communication program 22 may also be embodied as a mail client (e.g., the Microsoft Outlook personal information manager developed by Microsoft ™ Corporation or Lotus Notes ™ developed by the Lotus Notes Development Corporation).

The referrer machine 16 further includes a page server 17 that delivers web pages (e.g., markup language documents).

The network-based payment machine 14 includes one or more of a number of types of front-end servers, namely communications servers in the exemplary form of an application program interface (API) servers 24, and page servers 26 that deliver web pages, and processing servers in the exemplary form of CGI (or ISAPI) servers 28 that provide an intelligent interface to back-end servers. The network-based payment machine 14 further includes administrative and applications/functions 36 and e-mail servers 30. The e-mail servers 30 provide, inter alia, automated e-mail communications to users of the buyer machine 12, merchant machine 18, and referrer machine 16. The back-end servers further include database engine servers 32 that maintain and facilitate access to a database 34.

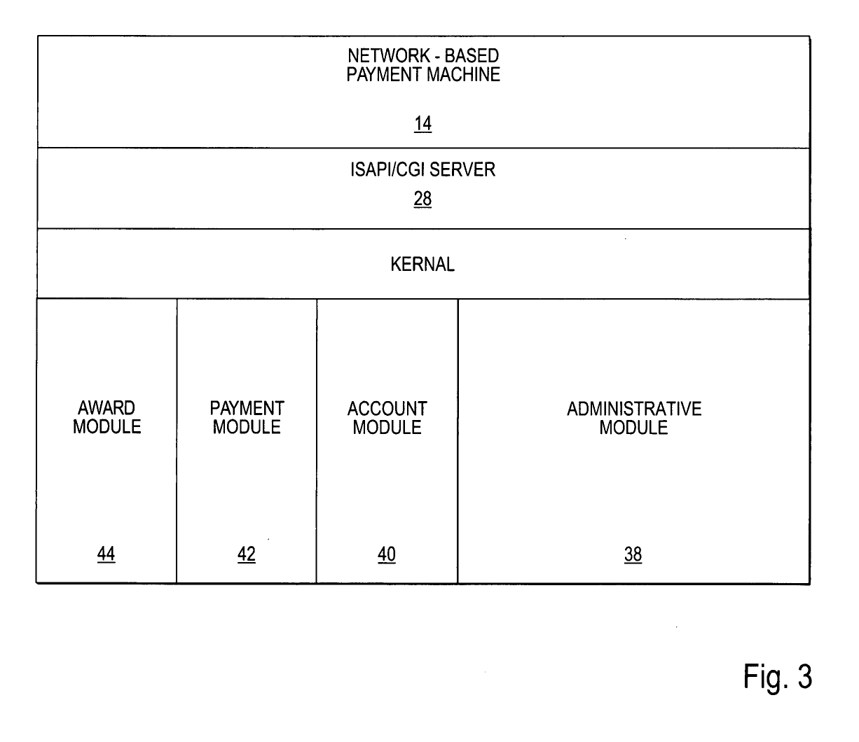

FIG. 3 is a block diagram illustrating an administrative module 38, an account module 40, a payment module 42, and an award module 44, according to an exemplary embodiment of the present invention, each of which forms part of the network-based payment machine 14.

The administrative module 38 executes on the network-based payment machine 14 and is used by an administrator that enters, edits and views bonus program parameters 91.

The account module 40 executes on an ISAPI/CGI server 28 of the network-based payment machine 14. The account module 40 establishes an account for a merchant on the network-based payment machine 14 by receiving and processing registration information associated with the merchant.

The payment module 42 executes under an ISAPI/CGI server 28 of the network-based payment machine 14. The payment module 42 receives and processes a payment from a buyer operating the buyer machine 12. The payment module 42 processes the payment by associating the payment to the proper merchant.

The award module 44 executes under an ISAPI/CGI server 28 of the network-based payment machine 14. The award module 44 determines which bonus program is associated with the merchant account, the referrer that referred the merchant to the payment service, and the award which is paid out to the referrer.

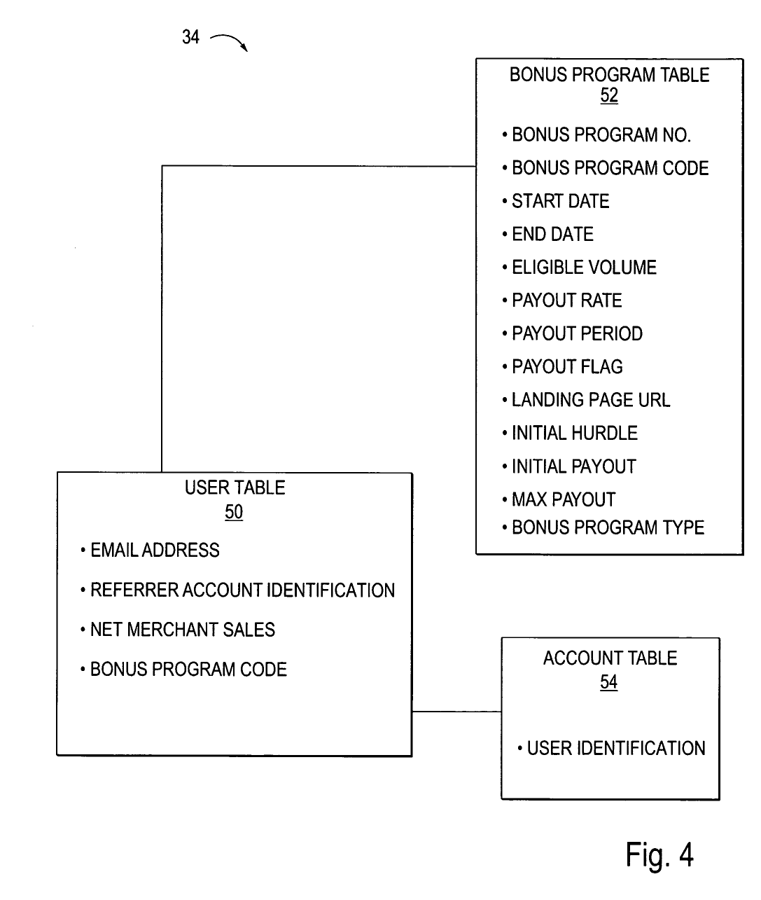

FIG. 4 is a database diagram illustrating an exemplary database 34, maintained and accessed via a database engine server 32, that supports the network-based payment machine 14. The database 34 may, in one embodiment, be implemented as a relational database, and includes a number of tables having entries, or records, that are linked by indices and keys. In an alternate embodiment, the database 34 may be implemented as a collection of objects in an object-oriented database.

The database 34 includes, among other tables, a user table 50, a bonus program table 52 and an account table 54. The bonus program table 52 includes a record or a bonus program entry 78 for each bonus program administered by the network-based payment machine 14. Each bonus program entry 78 includes bonus program parameters 91 that include a bonus program number 72, a bonus program code 64, a start date 92, an end date 94, an eligible volume 96, a payout rate 97, a payout period 98, a payout flag 99, a landing page universal resource locator (URL) 100, an initial hurdle 106, an initial payout 108, a maximum payout 110 and a bonus program type 111.

The bonus program number 72 is generated by the administrative module 38 in response to an administrator adding a new bonus program or in response to an administrator reconfiguring a new version of a general bonus program or in response to an administrator reconfiguring a new version of an unrestricted bonus program (the general and unrestricted bonus program types are described below).

The bonus program code 64 is generated by the administrative module 38 in response to an administrator adding a new bonus program or in response to an administrator reconfiguring a new version of a general bonus program or in response to an administrator reconfiguring a new version of an unrestricted bonus program. In addition, the administrative module 38 generates a unique bonus program code 64 for each referrer that is associated with the addition of a restricted bonus program (the restricted bonus program type is described below). The bonus program code 64 is utilized to associate a referrer with a specific bonus program.

The start date 92 identifies the first date this bonus program is effective (e.g., the first day that a merchant may sign up for an account responsive to promotion of the account by a referrer).

The end date 94 identifies the last date this bonus program is effective (e.g., the last day that a merchant may sign up for an account responsive to promotion of the account by a referrer).

The eligible volume 96 is utilized to identify payments that qualify for the bonus program. For example, a merchant may sell products or services in multiple electronic marketplaces; however, a referrer may only receive credit under a specific bonus program for payments made in markets that are identified by the eligible volume 96 field. For example, a referrer will receive credit for a payment made in Marketplace A provided that the eligible volume 96 field identifies Marketplace A. Other embodiments may capture payments made in more than one marketplace.

The payout rate 97 is the ongoing bonus rate after an initial payout. For example, a payout rate 97 of 5% would indicated a 5 cents payout for each dollar received after the initial payout.

The payout period 98 is utilized to calculate the last day that a payout will be made to the referrer. For example, a referrer that promotes the payment services to a merchant that signs up for a payment account that is established under a bonus program with an end date 94 of Jun. 30, 2003 and a payout period of 6 months may receive his or her last payment on or before Dec. 31, 2003.

The payout flag 99 may indicate whether payouts are immediately and electronically paid to the referrer's account on an ongoing basis or accrued and mailed to the merchant in the form of a check on a periodic basis. For example, an asserted payout flag 99 may indicate that a payout should be immediately awarded to a referrer's account.

The landing page URL 100 identifies a destination web page that a merchant is directed to by a referrer. A merchant that establishes an account based on the landing page URL 100 is associated with the corresponding referrer and the bonus program code 64.

The initial hurdle 106 defines the minimum amount of money that must be received into an account associated with a merchant before the referrer is eligible for the initial payout 108.

The initial payout 108 is the amount of money paid out to a referrer after the amount of money received into the account associated with the merchant exceeds the initial hurdle 106. For example, if the initial payout 108 is $10.00 USD and the initial hurdle 106 is $1,000.00 USD, then the referrer of the account would receive an initial payout of $10.00 USD after $1,000.00 USD is paid into the account.

The maximum payout 110 is the maximum benefit a referrer can receive based on a single referred account. For example, a maximum payout of $100.00 would limit the maximum total payout to the referrer of an account to $100.00 USD.

The initial hurdle 106, initial payout 108 and the maximum payout 110 may each be specified in multiple currencies 104 (Dollars, Francs, Yen, etc). Thus, a referrer may be incentivized in a currency that is native to the referrer and in values that are designed for the native currency.

The bonus program type 111 identifies the type of bonus program. The bonus program types include general, unrestricted, and restricted types. The general type of bonus program is offered by the payment service to incentivize a referrer to refer the payment service. The general bonus program is available to any referrer that uses the payment service. The general bonus program may be reconfigured to incentivize a prospective referrer by changing the start date 92, the end date 94, the eligible volume 96, the payout rate 97, the payout period 98, the payout flag 99, the landing page URL 100, the initial hurdle 106, the initial payout 108 or the maximum payout 110. Altering a single value will create a distinctive set of values (e.g., version) of the general bonus program as identified by a different bonus program number 72 and different bonus program code 64. Further, each distinctive set of values may not overlap in time (e.g., the start date 92 and the end date 94 that are associated with the general bonus program associated with a first bonus program code 64 will not overlap the start date 92 and the end date 94 that are associated with the general bonus program associated with a second bonus program code 74). Thus, the general bonus program may be reconfigured and reintroduced to referrers as a new version of the general bonus program.

The unrestricted type identifies an alternate type of bonus program that is also offered by the payment service to incentivize a referrer to refer the payment service. The unrestricted bonus program is available to all users of the payment service and may be configured by the payment service to incentivize users that may not respond to the general bonus program. The unrestricted bonus program may also be reconfigured as described above. Thus, the unrestricted bonus program may also be reconfigured and reintroduced to referrers as a new version of the unrestricted bonus program. Further, the new version of the unrestricted bonus program is identified with a bonus program number 72 and bonus program code 64 that is different from the old version of the unrestricted bonus program.

The restricted program is a bonus program type that may be offered by the payment service to an exclusive group of one or more referrers. The bonus program type 111 field associated with a restricted bonus program includes the email addresses of the referrers in addition to the restricted type. Each restricted bonus program is identified with one or more bonus program codes 64 whereby each referrer that is associated with the restricted bonus program may be identified with a unique bonus program code 64.

The user table 50 contains a record for each user of the network-based payment machine 14. The user may operate as a seller, buyer, a referrer or any combination thereof, and is associated with an account.

The user table 50 includes an e-mail address 60, a referrer account identification 62, a net merchant sales 63 and a bonus program code 64 in addition to other unidentified fields. Each user of the network-based payment machine 14 is represented by an entry in the user table 50. The e-mail address 60 is the e-mail address of the user. The referrer account identification 62 is a code that identifies the referrer (e.g., the referrer that promoted the payment service to the user associated with the present entry resulting in the user registering the account on the network-based payment machine 14). The net merchant sales 63 are the total payments that have been received into the account minus refunds minus charge backs minus reversals. Utilizing net sales rather than gross sales helps to defeat fraud and minimize abuse of the bonus program. The net merchant sales 63 are utilized to compute a possible award in the form of a payout to the associated referrer under the associated bonus program. The net merchant sales may be denominated in USD or any other currency.

The bonus program code 64 identifies the bonus program that is associated with the account. The referrer account identification 62 identifies the referrer that promoted the payment service to the present user (e.g., merchant) thereby resulting in the user establishing the account.

The account table 54 includes records user accounts. Each user account is associated with a user and is utilized to make payments to and receive payments from other users.

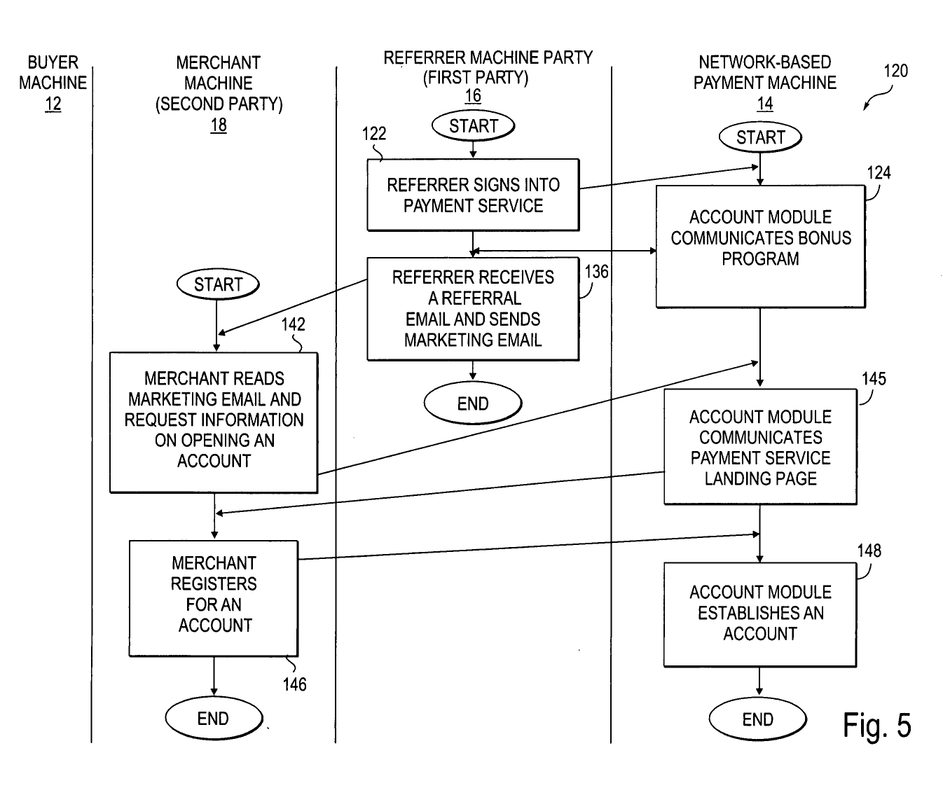

FIG. 5 is an interactive flowchart illustrating a method 120, according to an exemplary embodiment of the present invention, to incentivize a first party to refer a payment service to a second party. The merchant machine 18, referrer machine 16 and network-based payment machine 14 operations are illustrated.

At box 122, a referrer, accessing a referrer machine 16, signs into a payment service at the network-based payment machine 14.

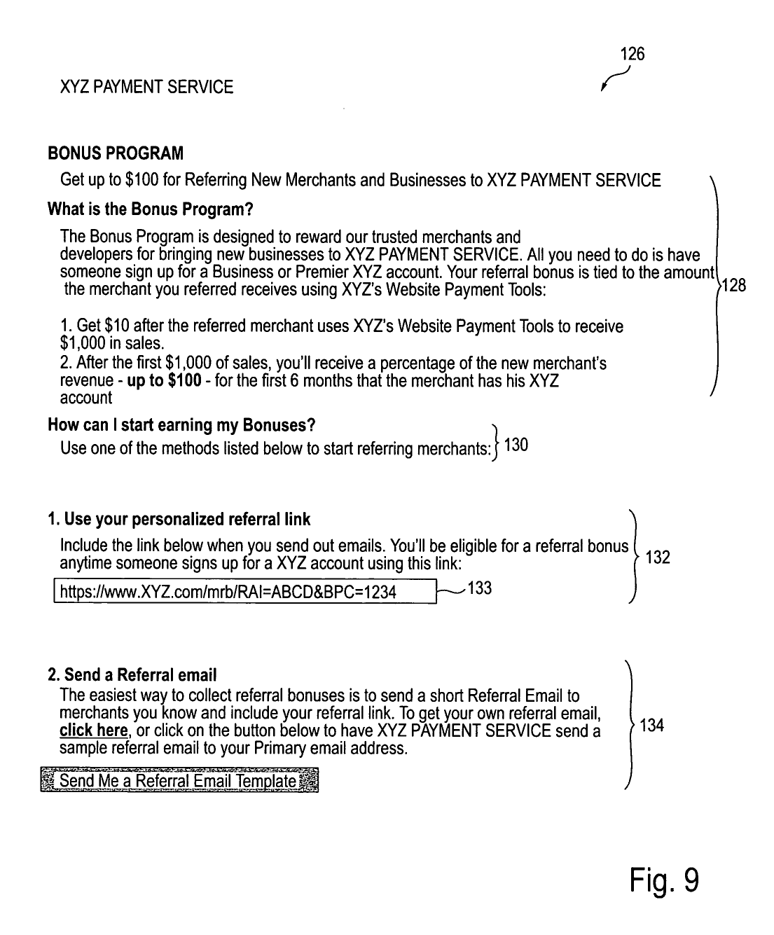

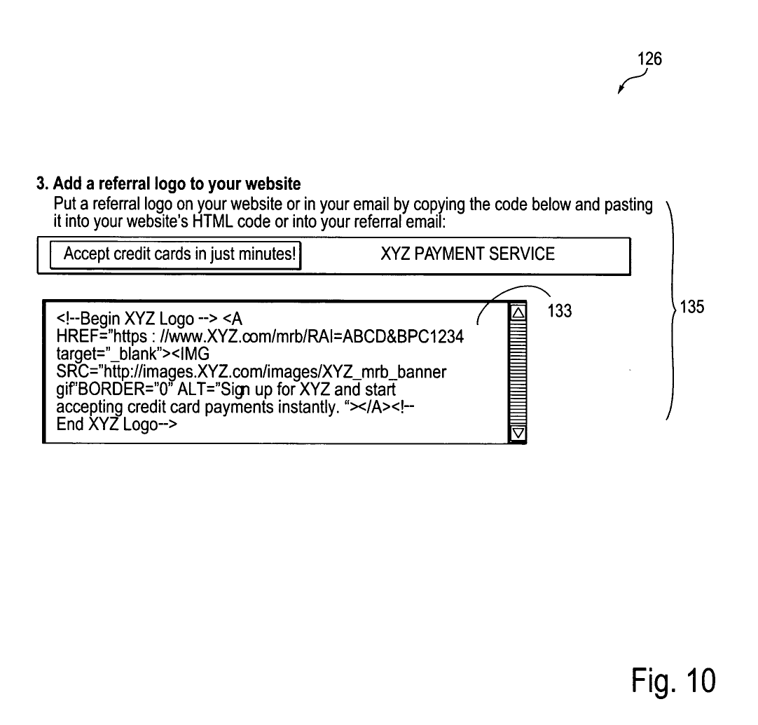

At box 124, the account module 40 communicates details of a bonus program with a user interface screen describing a bonus program. For example, FIGS. 9 and 10 illustrate a user interface screen 126, according to an exemplary embodiment of the present invention, in the form of a marketing web page. A text 128 describes the bonus program to the referrer.

A text 130 tells the referrer how they can start earning bonuses with the bonus program. Listed below the text 130 are three methods the referrer may utilize to initiate a referral of the payment service to a merchant. A text 132 illustrates a personalized referral link 133 that the referrer may copy into a marketing e-mail 140 that is sent to a merchant. A text 134 illustrates a second method to refer merchants whereby the network-based payment machine 14 sends a referral e-mail 138 to the referrer that the referrer may forward to the merchant. The referral e-mail 138 includes the same personalized referral link 133 as previously illustrated. A text 134 illustrates a third method describing how to add a referral logo to the referrer's website. The logo also includes the personalized referral link 133.

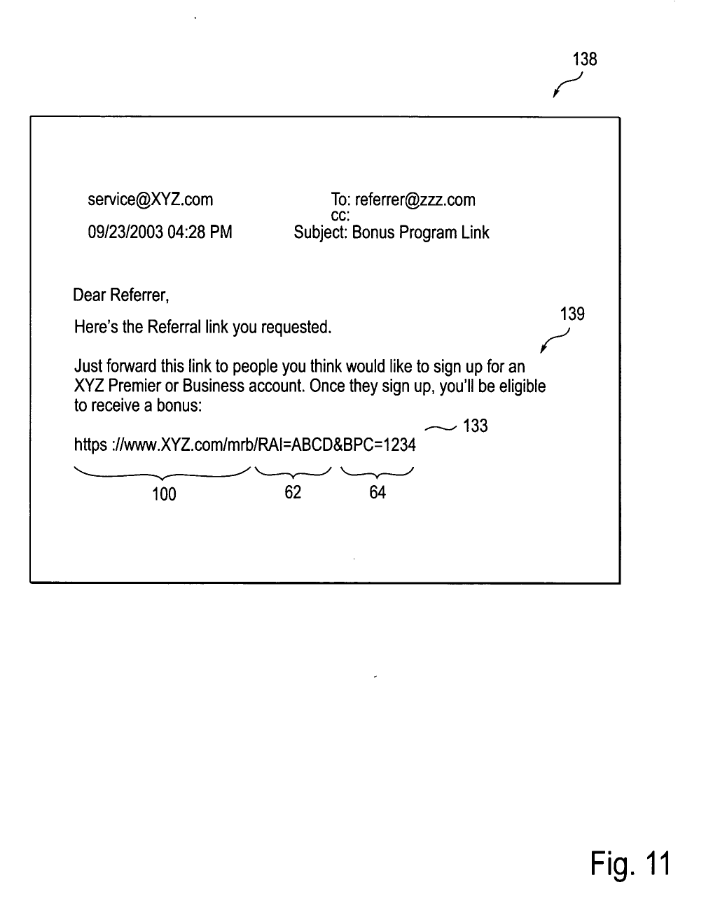

Returning to FIG. 5, at box 136, the referrer receives the referral e-mail 138 and sends the marketing e-mail 140. For example, FIG. 11 illustrates the referral e-mail 138, according to an exemplary embodiment of the present invention. The network-based payment machine 14 sends the referral e-mail 138 to the referrer at the referrer machine 16 responsive to a request by the referrer. The referral e-mail 138 includes a text 139, a telling the referrer to forward the link to people the referrer thinks would like to sign up for the XYZ payment service. The referral e-mail 138 includes the personalized referral link 133 that includes the landing page URL 100, a first identifier in the exemplary form of the referrer account identification 62 and a second identifier in the exemplary form of a bonus program code 64.

In an alternate embodiment, the personalized referral link 133 may not include a bonus program code 64 thus signifying the most recent version of the general program 74.

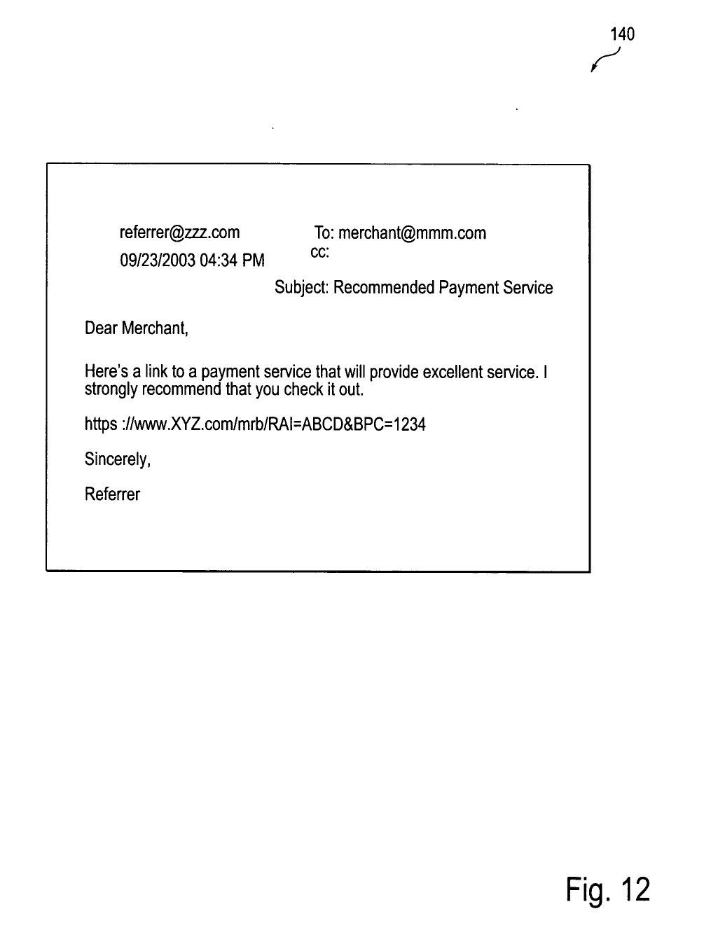

Next the referrer utilizes the referral e-mail 138 to create the marketing e-mail 140. For example, FIG. 12 illustrates the marketing e-mail 140, according to an exemplary embodiment of the present invention. The marketing e-mail 140 encourages the merchant to check out the payment services by suggesting the merchant select the personalized referral link 133.

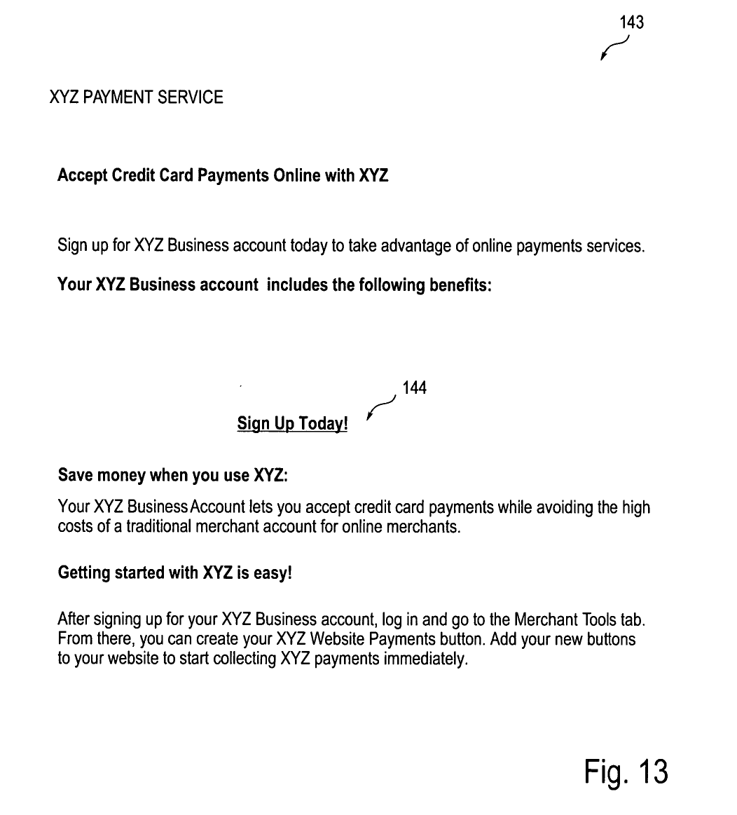

Returning to FIG. 5, at box 142, the merchant at the merchant machine 18 receives the marketing e-mail 140 and selects the personalized referral link 133. Selection of the personalized referral link 133 requests the network-based payment machine 14 to communicate the landing page, as specified by the landing page URL 100, to the merchant machine 18. In addition, the selection of the personalized referral link 133 will communicate the referrer account identification 62 and the bonus program code 64 to the network-based payment machine 14. For example, FIG. 13 illustrates a user interface screen 143, according to an exemplary embodiment of the present invention, in the form of a landing page. The user interface screen 143 provides the merchant with details regarding the payment service and encourages the merchant to register an account with the payment service. A text string 144 may be selected thus enabling the merchant to sign up for an account.

Returning to FIG. 5 at box 146, the merchant selects the text string 144 to open or establish an account with the payment service.

At box 148, the account module 40 on the network-based payment machine 14 establishes the account for the merchant. The account module 40 writes the referrer account identification 62 (e.g., ABCD), the bonus program code 64 (e.g., 1234) and the merchants email address 60 into the entry associated with the merchant in the user table 50 and the process ends. In another embodiment, the account module 40 may write the bonus program code 64 for the most recent version of the general bonus program if a bonus program code 64 is not communicated to the network-based payment machine 14.

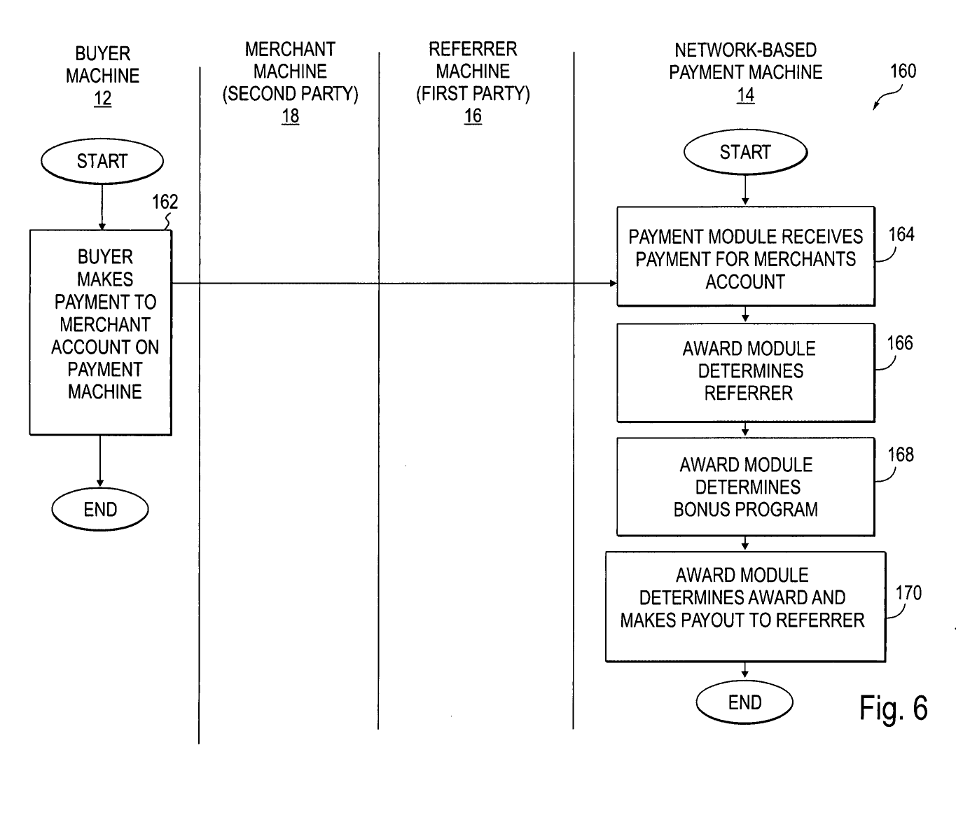

FIG. 6 is a flowchart illustrating a method 160, according to an exemplary embodiment of the present invention, to receive a payment. The buyer machine 12 and network-based payment machine 14 operations are illustrated.

At box 162, the buyer utilizing the buyer machine 12, makes a payment to a merchant account on the network-based payment machine 14.

At box 164, the payment module 42 receives an authorization for payment (e.g., in the form of an e-mail or other electronic communication) from the buyer. The authorization includes the e-mail address 60 of the buyer. The payment module 42 indexes into the user table 50 to match the corresponding e-mail address 60 thereby identifying the proper merchant.

At box 166, the award module 44 identifies the referrer by accessing the corresponding referrer account identification 62 in the entry associated with the merchant in the user table 50.

At box 168, the award module 44 identifies the proper bonus program in the user table 50 by accessing the bonus program code field 64.

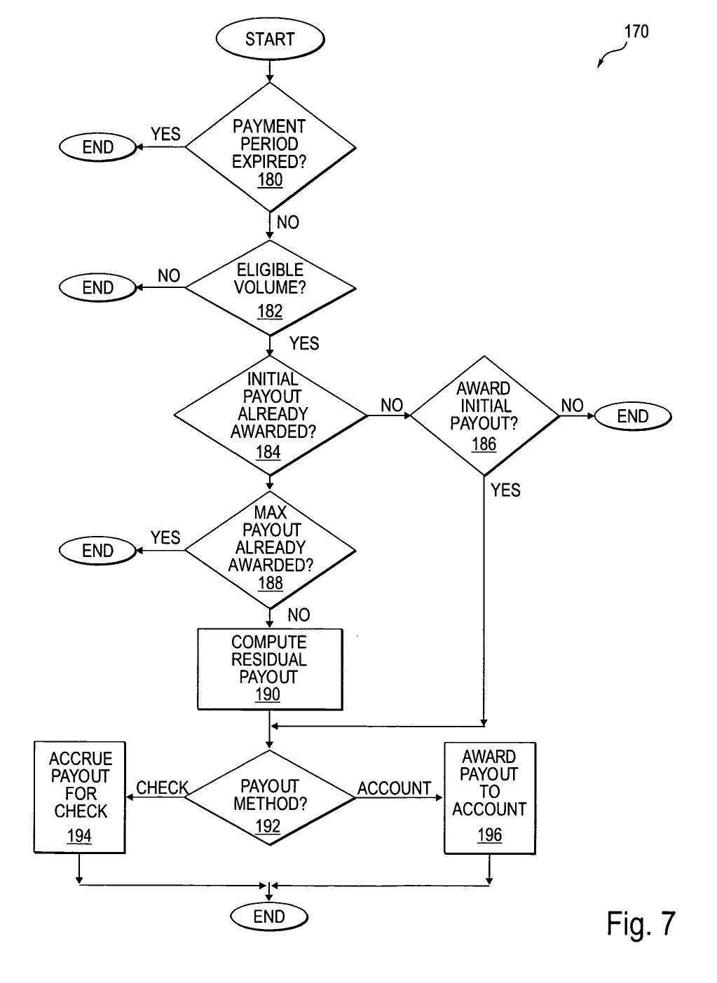

At box 170, the award module 44 matches the bonus program code 64 from the user table 50 to the bonus program code 64 in the bonus program table 52 thereby identifying the proper bonus program entry 78. The award module 44 utilizes the bonus program parameters 91 in the bonus program entry 78 to determine an award and make a payout to the referrer as illustrated in FIG. 7.

FIG. 7 is a flowchart illustrating a method 170, according to an exemplary embodiment of the present invention, to automatically determine an award and make a payout to a first party.

At decision box 180, the award module 44 determines if the payout period has expired by comparing the current date with a last day of payout that is computed based on the payout period 98. If the payout period has expired then processing ends. Otherwise processing continues at decision box 182.

At decision box 182, the award module 44 determines if the payment is eligible volume by comparing the location of the transaction that is associated with the payment with the eligible volume 96. If the location of the transaction is ineligible then processing ends. Otherwise the award module 44 adds the amount of the payment into the net merchant sales 63 and processing continues at decision box 184.

At decision box 184, the award module 44 determines if the initial payout 108 has already been awarded. If the initial payout 108 has already been awarded then processing continues at decision box 188. Otherwise processing continues at decision box 188.

At decision box 186, the award module 44 determines if the initial payout 108 should be awarded. If the net merchant sales field 62 is less than the initial hurdle 106 then processing ends. Otherwise the initial payout 108 should be awarded and processing continues at decision box 192.

At decision box 188, the award module 44 determines if the maximum payout 110 has already been awarded. If the maximum payout 110 has already been awarded then processing ends. Otherwise processing continues at box 190.

At box 190, the award module 44 multiplies the payout rate 97 by the payment to compute a residual payout and processing continues at decision box 192.

At decision box 192, the award module 44 determines the payout method by examining the payout flag 99. If the payout flag 99 indicates that the payout method is with a check then processing continues at box 194. Otherwise the payout method is via an account and processing continues at box 196. Other embodiments may include additional payout methods (e.g., points, debt cancellation, prizes, etc.).

At box 194, the award module 44 registers the initial payout or residual payout towards a final amount that is included in a check that is periodically sent to the merchant and processing ends.

At box 196, the award module 44 registers the initial payout or the residual payout to an account associated with a referrer and processing ends.

Returning to FIG. 6, an alternate embodiment to receive payment may include the network-based payment machine 14 receiving a payment for a merchant that has not established an account (e.g., a unilateral payment). In this embodiment the buyer would make a payment from the buyer machine 12 by selecting a web page served from the merchant machine 18. The web page includes a payment button that was inserted into the web page by a referrer (e.g., a web site developer) that published the web site on behalf of the merchant. A buyer that selects the payment button will generate a payment message that is communicated to the network-based payment machine 14 including an authorization to pay the merchant, the referrer account identification 62 and the bonus program code 64. The network-based payment machine 14 would not process the payment because the merchant has not yet established an account on the network-based payment machine 14. Once the merchant establishes an account then the network-based payment machine 14 is enabled to process the payment and award the referrer as previously described.

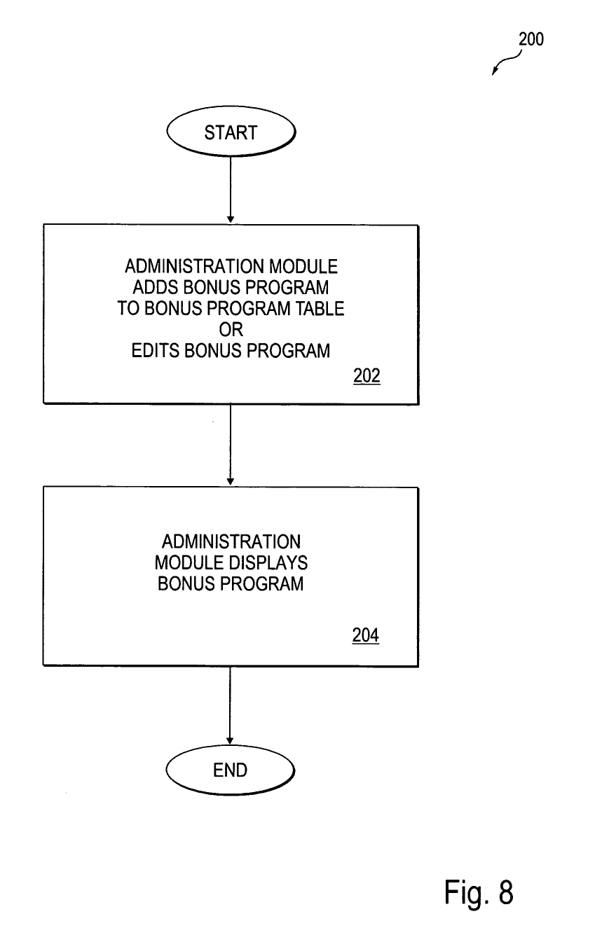

FIG. 8 is a flowchart illustrating a method 200, according to an exemplary embodiment of the present invention, to add, edit and view a bonus program.

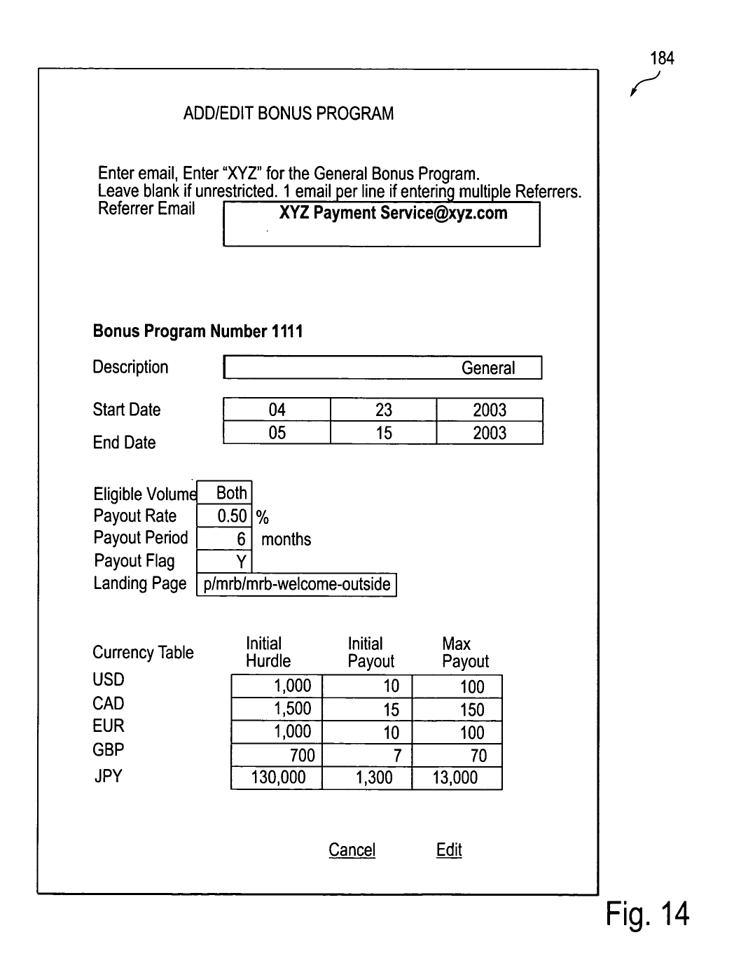

At box 202, the administrative module 38 adds a bonus program to the bonus program table 52 or edits an existing bonus program in the bonus program table 52 in response to an administrator entering information at a user interface screen. For example, FIG. 14 illustrates a user interface screen 184, according to an exemplary embodiment of the present invention, to add or edit a bonus program.

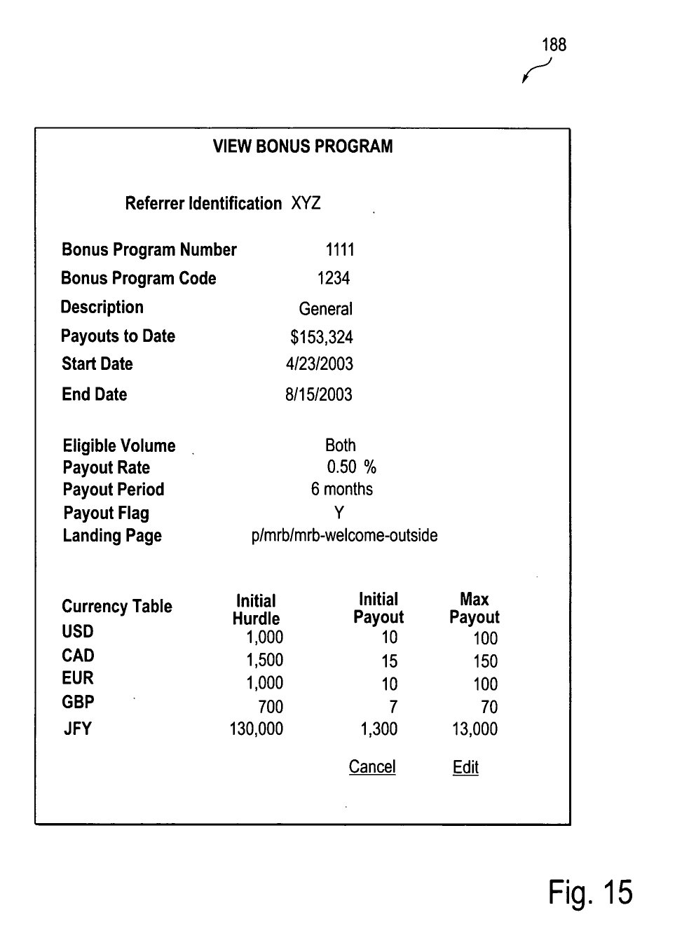

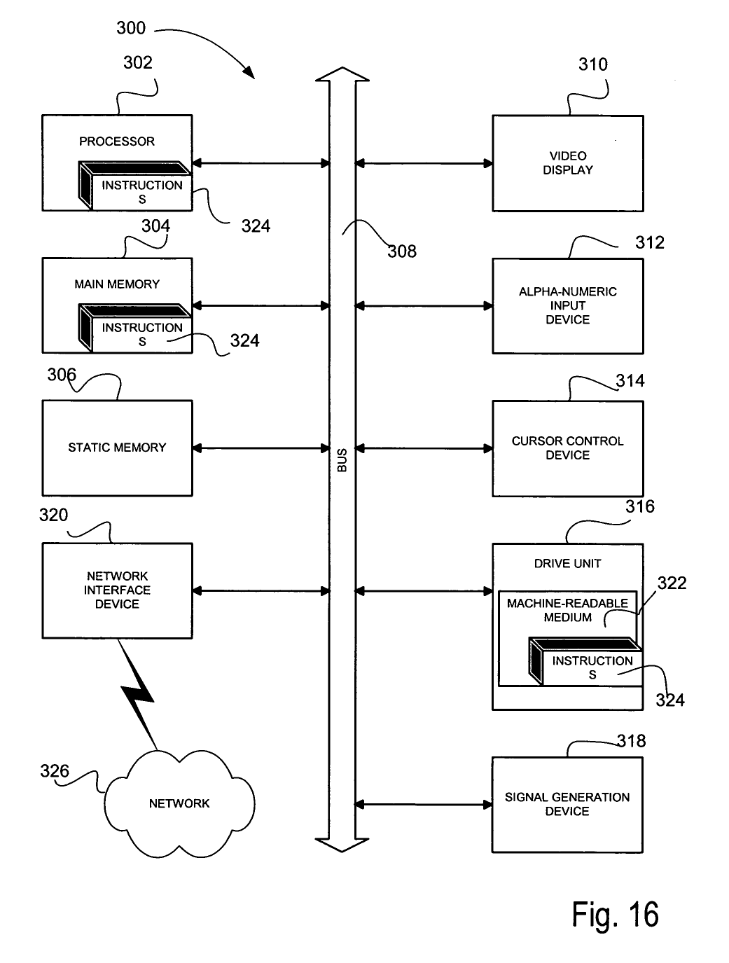

Returning to FIG. 8, at box 204, the administrative module 38 displays a bonus program in response to the administrator requesting the appropriate user interface screen. For example, FIG. 15 illustrates a user interface 188, according to an exemplary embodiment of the present invention, to view a bonus program.

FIG. 18 illustrates a diagrammatic representation of machine in the exemplary form of a computer system 300 within which a set of instructions, for causing the machine to perform any one or more of the methodologies discussed herein, may be executed. In alternative embodiments, the machine operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alpha-numeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and system to incentivize a first party to refer a payment service to a second party has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to incentivize a first party to refer a payment service to a second party, the method including:
establishing an account for the second party, wherein the account is associated with one of a plurality of bonus programs and wherein the account is further associated with the first party;
receiving a payment to the account for the second party; and
automatically awarding a payout to the first party based on the payment to the account for the second party and on the bonus program that is associated with the account.

2. The method of claim 1, wherein the establishing of the account further includes associating a first identifier with the first party and a second identifier with the bonus program.

3. The method of claim 2, wherein the second identifier is utilized to identify the bonus program from the plurality of bonus programs.

4. The method of claim 2, wherein the establishing of the account further includes communicating the first identifier and the second identifier to the second party via the first party, wherein the first identifier and the second identifier are utilized by the second party to establish the account.

5. The method of claim 1, including configuring the plurality of bonus programs, wherein each bonus program includes a plurality of payout conditions.

6. The method of claim 5, wherein the plurality of payout conditions is based on an at least one of an eligible volume, a payout rate, a payout period, an payout flag, an initial hurdle, an initial payout and a maximum payout.

7. The method of claim 1, wherein the payout includes an at least one of an initial payout and a residual payout.

8. The method of claim 1, wherein the first party is eligible to participate in a plurality of bonus programs.

9. The method of claim 6, wherein the plurality of bonus programs includes an at least one of a general bonus program, an unrestricted bonus program, and a restricted bonus program.

10. The method of claim 1, wherein the payout is tendered in at least one of a plurality of national currencies.

11. A system to incentivize a first party to refer a payment service to a second party, the system including:
an account module to establish an account for the second party, wherein the account is associated with one of a plurality of bonus programs and wherein the account is further associated with the first party;
a payment module to receive a payment for the second party in the account; and
an award module automatically to award a payout to the first party based on the payment to the account and the bonus program that is associated with the account.

12. The system of claim 11, wherein the account module to establish the account further is further to associate a first identifier with the first party and a second identifier with the bonus program.

13. The system of claim 12, wherein the award module is to utilize the second identifier to identify the bonus program from the plurality of bonus programs.

14. The system of claim 12, wherein the account module to establish the account further is further to communicate the first identifier and the second identifier to the second party via the first party, wherein the first identifier and the second identifier are utilized by the second party to establish the account.

15. The system of claim 11, including an administrative module to configure the plurality of bonus programs, wherein each bonus program includes a plurality of payout conditions.

16. The system of claim 15, wherein the plurality of payout conditions is based on an at least one of an eligible volume, a payout rate, a payout period, an payout flag, an initial hurdle, an initial payout and a maximum payout.

17. The system of claim 11, wherein the payout includes an at least one of an initial payout and a residual payout.

18. The system of claim 11, wherein the first party is eligible to participate in a plurality of bonus programs.

19. The system of claim 16, wherein the plurality of bonus programs includes an at least one of a general bonus program, an unrestricted bonus program, and a restricted bonus program.

20. The system of claim 11, wherein the payout is tendered in at least one of a plurality of national currencies.

21. A machine readable medium storing a set of instructions that, when executed by a machine, cause the machine to:
establish an account for the second party, wherein the account is associated with one of a plurality of bonus programs and wherein the account is further associated with the first party;
receive a payment for the second party in the account; and
automatically award a payout to the first party based on the payment to the account and the bonus program that is associated with the account.

22. A system to incentivize a first party to refer a payment service to a second party, the system including:
a first means for establishing an account for the second party, wherein the account is associated with one of a plurality of bonus programs and wherein the account is further associated with the first party;
a second means for receiving a payment for the second party in the account; and
a third means for automatically awarding a payout to the first party based on the payment to the account and the bonus program that is associated with the account.
